(19) United States
(12) Patent Application Publication
(10) Pub. No.: US 2020/0230713 A1
(43) Pub. Date: Jul. 23, 2020

(54) LENGTH MEASUREMENT CONTROL APPARATUS, MANUFACTURING SYSTEM, LENGTH MEASUREMENT CONTROL METHOD, AND NON-TRANSITORY COMPUTER READABLE MEDIUM STORING LENGTH MEASUREMENT CONTROL PROGRAM

(71) Applicant: MITSUBISHI ELECTRIC CORPORATION, Tokyo (JP)

(72) Inventor: Keisuke MASUDA, Tokyo (JP)

(73) Assignee: MITSUBISHI ELECTRIC CORPORATION, Tokyo (JP)

(21) Appl. No.: 16/089,277

(22) PCT Filed: Jun. 15, 2016
(86) PCT No.: PCT/JP2016/067797

§ 371 Date: Sep. 27, 2018

(51) Int. Cl. B23B 49/00; G01B 21/02

(52) U.S. Cl. CPC B23B 49/00; G01B 21/02

(57) ABSTRACT

A receiving unit of a length measurement control apparatus receives fitting information that indicates a fitting state between parts of a product that was assembled from a group of parts including members machined using a tool. A determination unit of the length measurement control apparatus determines whether to measure a length dimension of the tool in order to correct the machining position in accordance with a change in the length dimension of the tool, on the basis of whether the fitting state indicated in the fitting information received by the receiving unit is outside a threshold range.

### TECHNICAL FIELD

The present invention relates to a length measurement control apparatus, a manufacturing system, a length measurement control method, and a length measurement control program.

### BACKGROUND ART

With a lathe or similar machining apparatus, when machining is repeated numerous times, the cutting tool wears little-by-little and machining precision declines. Due to this, machining precision is maintained by taking a length measurement of a dimension of a machined workpiece, a cutting edge position of the cutting tool, or the like using a microscope or a length measuring device such as a probe, and correcting the machining position according to the length measurement results.

With the technique described in Patent Literature 1, instead of a length measurement being performed each time a workpiece is to be machined, the length measurement is performed at a predetermined timing such as at a start-up time of the machining apparatus or periodically.

With the technique described in Patent Literature 2, a temperature of a servomotor in the machining apparatus is measured, in real time, when machining the workpiece, and this temperature information is compared with temperature threshold information stored in a system. By detecting a moment at which the load applied to the work piece or the cutting tool is greater than at normal, the length measurement is performed.

### CITATION LIST

### Patent Literature

Patent Literature 1: JP10-296591

Patent Literature 2: JP2004-34187

### SUMMARY OF INVENTION

### Technical Problem

With methods in which the length measurement is performed at a predetermined timing such as when the length measurement is performed at the start-up time of the machining apparatus or the length measurement is performed periodically, the experience of a worker is needed to identify the length measurement timing at which decreases in workpiece machining efficiency can be minimized.

With methods in which the length measurement timing is determined by measuring, in real time, the temperature of the servomotor in the machining apparatus and comparing this temperature information with the temperature threshold information stored in the system, it may be possible to suppress decreases in machining precision caused by heat, but it is not possible to suppress decreases in machining precision caused by wearing of the cutting tool.

In variety and variable quantity production, the wear rate of the cutting tool fluctuates according to the machining method and number of workpieces. Consequently, regardless of which of the aforementioned methods is used to determine the length measurement timing, there are problems such as not being able to maintain machining precision and decreased workpiece machining efficiency.

An object of the present invention is to determine a length measurement timing at which decreases in machining precision and in machining efficiency can be suppressed, regardless of the presence/absence of the experience of a worker and regardless of whether the production is variety and variable quantity production.

### Solution to Problem

According to an aspect of the present invention, a length measurement control apparatus, including:

a receiving unit to receive fitting information indicating a fitting state between parts of a product assembled from a group of parts including a member machined using a tool; and

a determination unit to determine whether to measure a length dimension of the tool in order to correct a machining position in accordance with a change in the length dimension of the tool, on the basis of whether the fitting state indicated in the fitting information received by the receiving unit is outside a threshold range.

### Advantageous Effects of Invention

With the present invention, whether to measure the length dimension of a tool, that is, whether to perform a length measurement for correcting a machining position in accordance with a change in the length dimension of the tool is determined by whether a fitting state between parts in an assembled product is outside a threshold range. As such, it is possible to determine the length measurement timing at which decreases in machining precision and in machining efficiency can be suppressed, regardless of the presence/absence of the experience of a worker and regardless of whether the production is variety and variable quantity production.

### BRIEF DESCRIPTION OF DRAWINGS

FIG. 1 is a block diagram illustrating the configuration of a manufacturing system according to Embodiment 1.

FIG. 2 is a block diagram illustrating the configuration of a machining apparatus according to Embodiment 1.

FIG. 3 is a block diagram illustrating the configuration of an assembly apparatus according to Embodiment 1.

FIG. 4 is a block diagram illustrating the configuration of an inspection apparatus according to Embodiment 1.

FIG. 5 is a block diagram illustrating the configuration of a length measurement control apparatus according to Embodiment 1.

FIG. 6 is a flowchart illustrating operations of the machining apparatus according to Embodiment 1.

FIG. 7 is a flowchart illustrating operations of the assembly apparatus according to Embodiment 1.

FIG. 8 is a flowchart illustrating operations of the length measurement control apparatus according to Embodiment 1.

FIG. 9 is a flowchart illustrating operations of the machining apparatus according to Embodiment 1.

FIG. 10 is a flowchart illustrating operations of the length measurement control apparatus according to Embodiment 1.

FIG. 11 is a flowchart illustrating operations of the inspection apparatus according to Embodiment 1.

FIG. 12 is a flowchart illustrating operations of the length measurement control apparatus according to Embodiment 1.

FIG. 13 is a flowchart illustrating operations of the length measurement control apparatus according to Embodiment 1.

### DESCRIPTION OF EMBODIMENTS

Hereinafter, embodiments of the present invention will be described with reference to the drawings. It should be noted that, in the individual drawings, same or corresponding parts are denoted by the same reference numerals. In the description of the embodiments, the description of the same or corresponding parts will be omitted or simplified as necessary.

### Embodiment 1

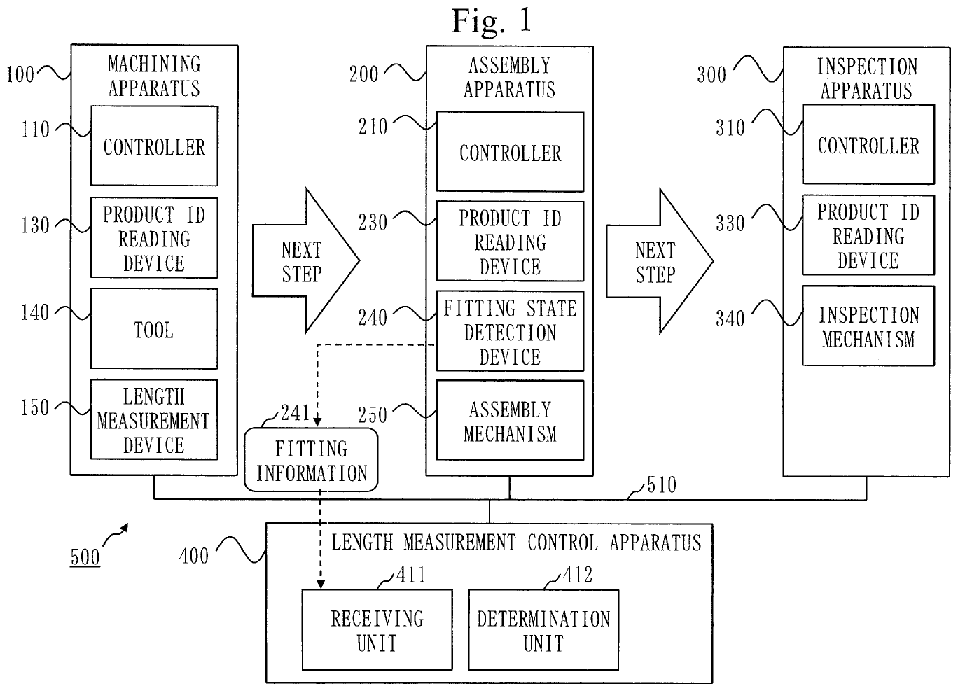

The present embodiment will be described with reference to FIGS. 1 to 13.

### Description of Configuration

The configuration of a manufacturing system 500 according to Embodiment 1 will be described with reference to FIG. 1.

The manufacturing system 500 includes a machining apparatus 100, an assembly apparatus 200, an inspection apparatus 300, and a length measurement control apparatus 400.

The machining apparatus 100 is an apparatus that is used in a machining step. The machining apparatus 100 includes a controller 110, a product ID reading device 130, a tool 140, and a length measurement apparatus 150. “ID” is an abbreviation for “identifier.”

The assembly apparatus 200 is an apparatus that is used in an assembly step after the machining step. The assembly apparatus 200 includes a controller 210, a product ID reading device 230, a fitting state detection device 240, and an assembly mechanism 250.

The inspection apparatus 300 is an apparatus that is used in an inspection step after the assembly step. The inspection apparatus 300 includes a controller 310, a product ID reading device 330, and an inspection mechanism 340.

The length measurement control apparatus 400 is an apparatus that determines a timing at which to perform a length measurement of the tool 140 used in the machining step. The length measurement control apparatus 400 includes a receiving unit 411 and a determination unit 412.

The length measurement control apparatus 400 is connected to the machining apparatus 100, the assembly apparatus 200, and the inspection apparatus 300 via a network 510. Specifically, the network 510 is a LAN. “LAN” is an abbreviation for “Local Area Network.”

Fitting information 241 is sent and received via the network 510 between the fitting state detection device 240 of the assembly apparatus 200 and the receiving unit 411 of the length measurement control apparatus 400.

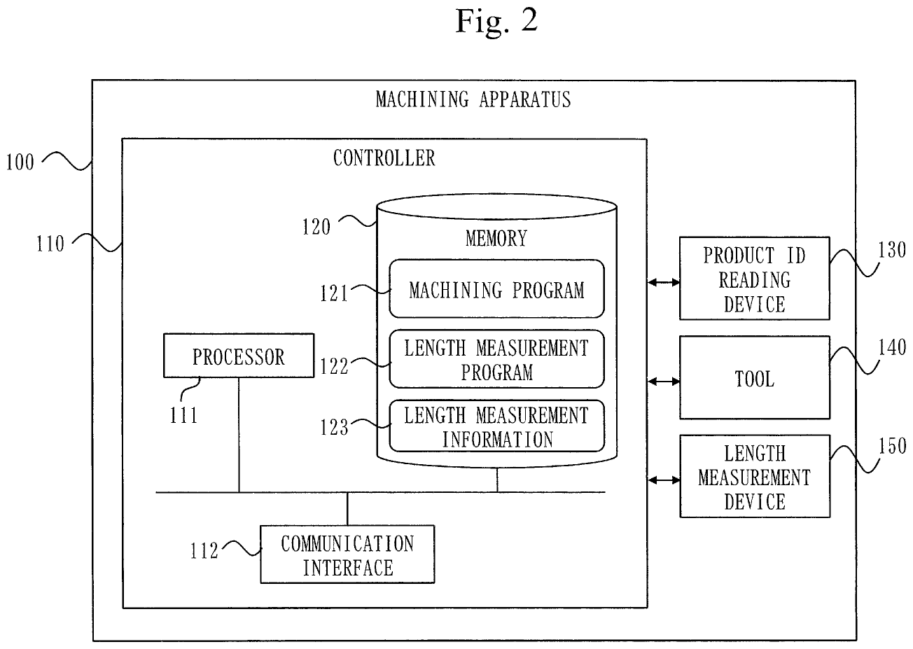

The configuration of the machining apparatus 100 according to the present embodiment will be described with reference to FIG. 2.

As described above, the machining apparatus 100 includes the controller 110, the product ID reading device 130, the tool 140, and the length measurement device 150.

The controller 110 is a microcomputer or other computer. The controller 110 includes a processor 111 and also includes other hardware, such as a communication interface 112 and a memory 120. The processor 111 is connected to the other hardware via a signal line, and controls the other hardware.

The processor 111 is an IC that carries out processing. “IC” is an abbreviation for “Integrated Circuit.” Specifically, the processor 111 is a CPU. “CPU” is an abbreviation for “Central Processing Unit.”

The communication interface 112 is an interface that connects to the length measurement control apparatus 400 via the network 510. The communication interface 112 includes a receiver that receives data and a transmitter that sends data. Specifically, the communication interface 112 is a communication chip or an NIC. “NIC” is an abbreviation for “Network Interface Card.”

A machining program 121, a length measurement program 122, and length measurement information 123 are stored in the memory 120. The machining program 121 and the length measurement program 122 are read into the processor 111 and executed by the processor 111. The length measurement information 123 is information related to a dimensional error of the tool 140. Specifically, the memory 120 is a flash memory or a RAM. “RAM” is an abbreviation for “Random Access Memory.”

The product ID reading device 130 is a device for uniquely identifying products. Specifically, the product ID reading device 130 is a barcode reader or an RFID reader. “RFID” is an abbreviation for “Radio Frequency Identification.”

The tool 140 is a tool for machining a member. Specifically, the tool 140 is a cutting tool.

The length measurement device 150 is a device for performing length measurements of the tool 140 to detect the dimensional error of the tool 140.

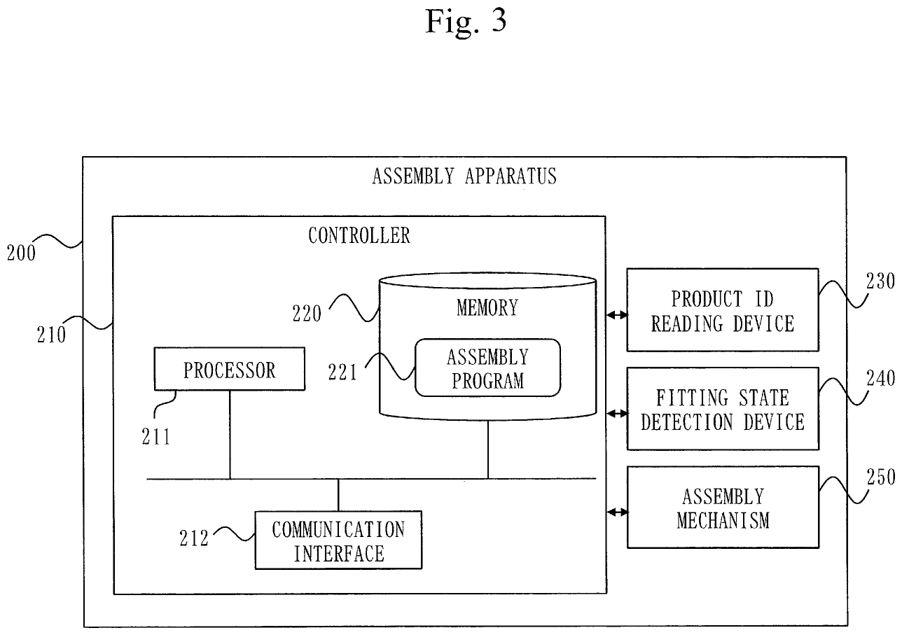

The configuration of the assembly apparatus 200 according to the present embodiment will be described with reference to FIG. 3.

As described above, the assembly apparatus 200 includes the controller 210, the product ID reading device 230, the fitting state detection device 240, and the assembly mechanism 250.

The controller 210 is a microcomputer or other computer. The controller 210 includes a processor 211 and also includes other hardware, such as a communication interface 212 and a memory 220. The processor 211 is connected to the other hardware via a signal line, and controls the other hardware.

The processor 211 is an IC that carries out processing. Specifically, the processor 211 is a CPU.

The communication interface 212 is an interface that connects to the length measurement control apparatus 400 via the network 510. The communication interface 212 includes a receiver that receives data and a transmitter that sends data. Specifically, the communication interface 212 is a communication chip or an NIC.

An assembly program 221 is stored in the memory 220. The assembly program 221 is read into the processor 211 and executed by the processor 211. Specifically, the memory 220 is a flash memory or a RAM.

The product ID reading device 230 is a device for uniquely identifying products. Specifically, the product ID reading device 230 is a barcode reader or an RFID reader.

The fitting state detection device 240 is a device for detecting, using temperature, current value, or the like, the fitting state at a time of product assembly.

The assembly mechanism 250 is equipment for assembling the product.

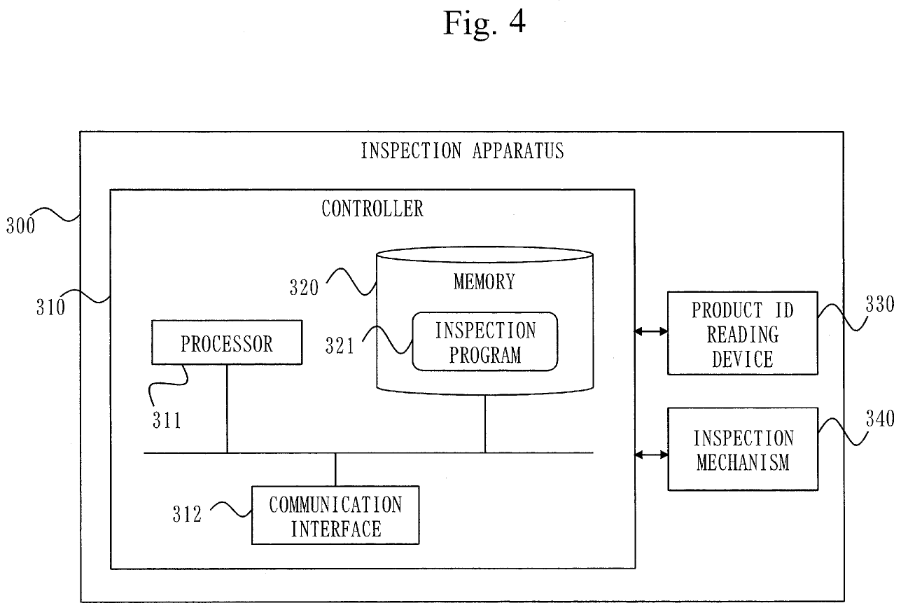

The configuration of the inspection apparatus 300 according to the present embodiment will be described with reference to FIG. 4.

As described above, the inspection apparatus 300 includes the controller 310, the product ID reading device 330, and the inspection mechanism 340.

The controller 310 is a microcomputer or other computer. The controller 310 includes a processor 311 and also includes other hardware, such as a communication interface 312 and a memory 320. The processor 311 is connected to the other hardware via a signal line, and controls the other hardware.

The processor 311 is an IC that carries out processing. Specifically, the processor 311 is a CPU.

The communication interface 312 is an interface that connects to the length measurement control apparatus 400 via the network 510. The communication interface 312 includes a receiver that receives data and a transmitter that sends data. Specifically, the communication interface 312 is a communication chip or an NIC.

An inspection program 321 is stored in the memory 320. The inspection program 321 is read into the processor 311 and executed by the processor 311. Specifically, the memory 320 is a flash memory or a RAM.

The product ID reading device 330 is a device for uniquely identifying products. Specifically, the product ID reading device 330 is a barcode reader or an RFID reader.

The inspection mechanism 340 is equipment for inspecting the product.

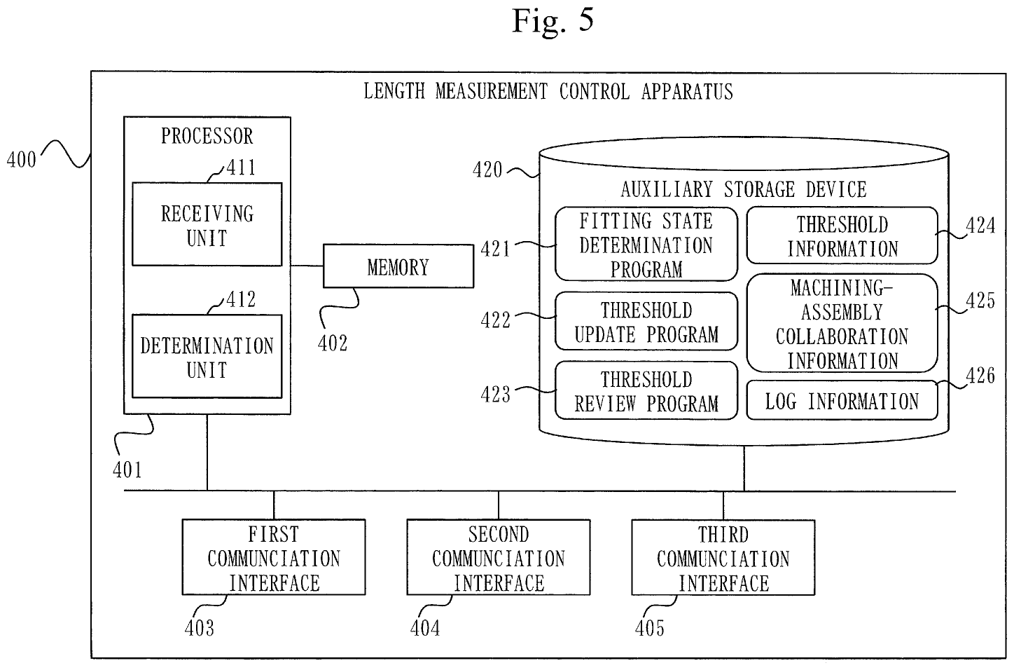

The configuration of the length measurement control apparatus 400 according to the present embodiment will be described with reference to FIG. 5.

The length measurement control apparatus 400 is a server computer or other computer. The length measurement control apparatus 400 includes a processor 401 and also includes other hardware, such as a memory 402, a first communication interface 403, a second communication interface 404, a third communication interface 405, and an auxiliary storage device 420. The processor 401 is connected to the other hardware via a signal line, and controls the other hardware.

The length measurement control apparatus 400 includes, as functional elements, the receiving unit 411 and the determination unit 412. The functions of the “units”, such as the receiving unit 411 and the determination unit 412, are realized by software.

The processor 401 is an IC that carries out processing. Specifically, the processor 401 is a CPU.

Specifically, the memory 402 is a flash memory or a RAM.

The first communication interface 403 is an interface for controlling the machining apparatus 100 via the network 510. The second communication interface 404 is an interface for collecting information from the assembly apparatus 200 via the network 510. The third communication interface 405 is an interface for collecting information from the inspection apparatus 300 via the network 510. The first communication interface 403, the second communication interface 404, and the third communication interface 405 each include a receiver that receives data and a transmitter that sends data. Specifically, the first communication interface 403, the second communication interface 404, and the third communication interface 405 are communication chips or NICs. However, a single communication chip or NIC may be used for the first communication interface 403, the second communication interface 404, and the third communication interface 405.

Programs that realize the functions of the “units”, such as a fitting state determination program 421, a threshold update program 422, and a threshold review program 423, are stored in the auxiliary storage device 420. Furthermore, threshold information 424, machining-assembly collaboration information 425, and log information 426 are stored in the auxiliary storage device 420. The threshold information 424, the machining-assembly collaboration information 425, and the log information 426 are stored as files or as tables of a database. While not illustrated in the drawings, an OS is also stored in the auxiliary storage device 420. “OS” is an abbreviation for “Operating System.” The programs and the OS stored in the auxiliary storage device 420 are loaded into the memory 402 and executed by the processor 401. Note that a portion or all of the programs that realize the functions of the “units” may be incorporated into the OS. Specifically, the auxiliary storage device 420 is a flash memory or a HDD. “HDD” is an abbreviation for “Hard Disk Drive.”

The length measurement control apparatus 400 may include, as hardware, an input device and a display.

Specifically, the input device is a mouse, a keyboard, or a touch panel. Specifically, the display is an LCD. “LCD” is an abbreviation for “Liquid Crystal Display.”

The length measurement control apparatus 400 may include a plurality of processors in place of the processor 401. Responsibility for executing the programs to realize the functions of the “units” is shared among the plurality of processors. Each individual processor is an IC that carries out processing, similar to the processor 401.

Information, data, signal values, and variable values that indicate the results of the processing of the “units” are stored in the memory 402, the auxiliary storage device 420, or in a resistor or a cache memory in the processor 401.

The programs that realize the functions of the “units” may be stored on a portable recording medium such as a magnetic disk or an optical disk.

### Description of Operations

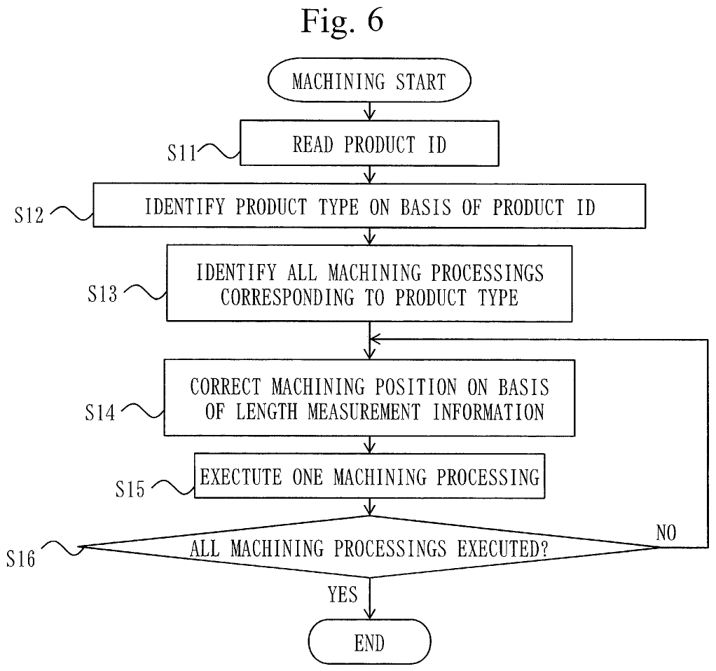

Operations of the manufacturing system 500 according to the present embodiment will be described with reference to FIGS. 6 to 13. The operations of the manufacturing system 500 correspond to a manufacturing method according to the present embodiment. Additionally, operations of the length measurement control apparatus 400 correspond to a length measurement control method according to the present embodiment. Moreover, the operations of the length measurement control apparatus 400 correspond to processing procedures of a length measurement control program according to the present embodiment.

As an example of a manufacturing method of a product, a case will be described in which, first, members are machined into parts by the machining apparatus 100, then the parts are assembled into products by the assembly apparatus 200, and finally the products are inspected by the inspection apparatus 300 and only good products are shipped.

FIG. 6 illustrates a flow in which the machining program 121 is executed by the machining apparatus 100 and a member is machined into a part using the tool 140.

In step S11, the controller 110 uses the product ID reading device 130 to read a unique product ID associated with a member. In step S12, the controller 110 identifies a product type on the basis of the product ID. The product type is a type that is determined by classifying the product according to the machined shape of the product. In step S13, the controller 110 reads information of machining processings corresponding to the product type from the memory 120. Each of pieces of the information of the machining processings includes information of the machining position, the machining method, and the tool 140 to be used when machining. In step S14, the controller 110 corrects the machining position on the basis of the length measurement information 123 of the tool 140 stored in the memory 120 in order to maintain machining precision. In step S15, the controller 110 machines the member using the tool 140 by executing one machining processing. In step S16, the controller 110 ends the processing if all of the machining processings have been executed, and the controller 110 executes the processing of step S14 again if all of the machining processings have not been executed.

As described above, in the present embodiment, the machining apparatus 100 acquires, from the memory 120, the length measurement information 123 that indicates the length measurement results, which are the results of measuring the length dimension of the tool 140. The machining apparatus 100 corrects the machining position according to the length measurement results indicated in the acquired length measurement information 123. The machining apparatus 100 applies the corrected machining position and uses the tool 140 to machine the member.

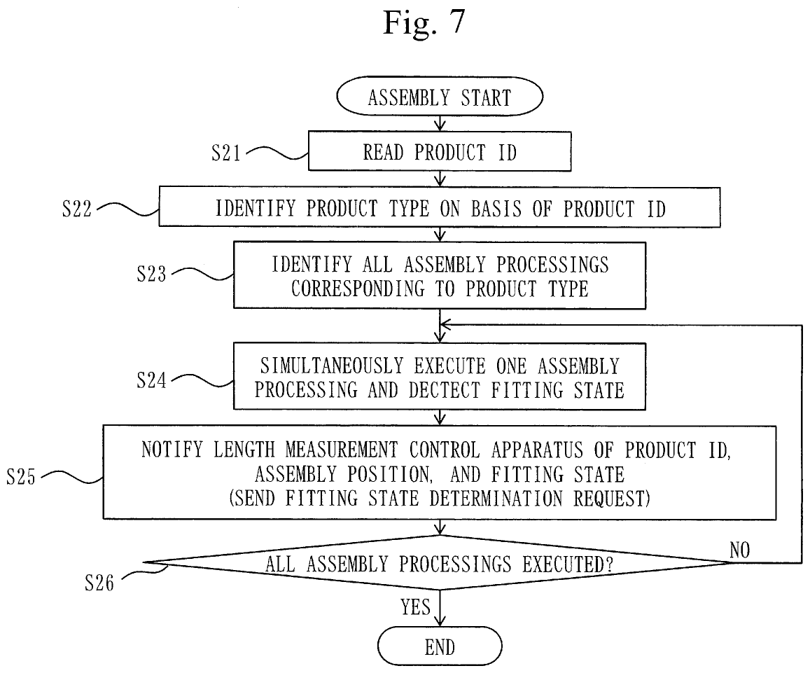

FIG. 7 illustrates a flow in which the assembly program 221 is executed by the assembly apparatus 200 and parts are assembled into a product using the assembly mechanism 250.

In step S21, the controller 210 uses the product ID reading device 230 to read a unique product ID associated with a part. In step S22, the controller 210 identifies the product type on the basis of the product ID. In step S23, the controller 210 reads information of assembly processings corresponding to the product type from the memory 220. Each of pieces of the information of the assembly processings includes information of the assembly position and the assembly method. In step S24, the controller 210 assembles the parts using the assembly mechanism 250 by executing one assembly processing. At the same time, the controller 210 uses the fitting state detection device 240 to detect the fitting state. In step S25, the controller 210 sends the fitting information 241 indicating the product ID, the assembly position, and the fitting state to the length measurement control apparatus 400 via the communication interface 212. As a result, a fitting state determination request is sent. In step S26, the controller 210 ends the processing if all of the assembly processings have been executed, and the controller 210 executes the processing of step S24 again if all of the assembly processings have not been executed.

As described above, in the present embodiment, the assembly apparatus 200 assembles a product from a group of parts. Thereafter, the assembly apparatus 200 detects the fitting state between the parts of the product. Then, the assembly apparatus 200 sends the fitting information 241 indicating the detected fitting state to the length measurement control apparatus 400.

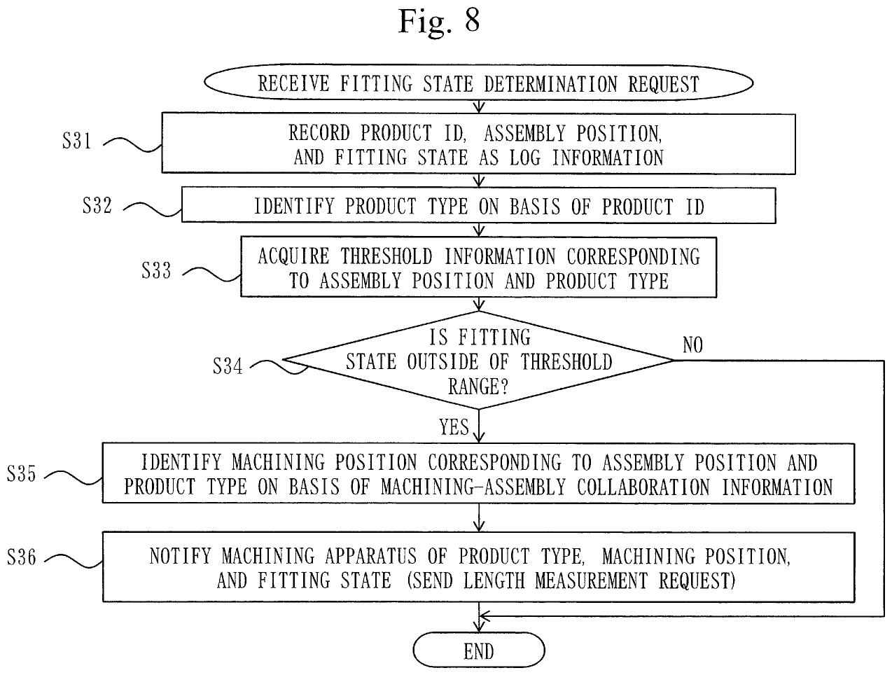

FIG. 8 illustrates a flow in which the fitting state determination program 421 is executed by the length measurement control apparatus 400 that received the fitting state determination request via the second communication interface 404, and a decline in machining precision is detected at the time of assembly.

In step S31, the determination unit 412 saves the information of the product ID, the assembly position, and the fitting state, included in the fitting information 241 which was received by the receiving unit 411, as the log information 426 in the auxiliary storage device 420. In step S32, the determination unit 412 identifies the product type on the basis of the product ID. In step S33, the determination unit 412 acquires, from the auxiliary storage device 420, the threshold information 424 that corresponds to the assembly position and the product type. In step S34, the determination unit 412 determines whether the fitting state is outside the threshold range of the threshold information 424. When the fitting state is outside the threshold range, the determination unit 412 determines that the machining precision has declined and executes the processing of step S35. In step S35, the determination unit 412 identifies the machining position that corresponds to the assembly position and the product type on the basis of the machining-assembly collaboration information 425. In step S36, the determination unit 412 notifies the machining apparatus 100 of the product type, the machining position, and the fitting state via the first communication interface 403. As a result, a length measurement request is sent. Meanwhile, in step S34, when the fitting state is within the threshold range, the determination unit 412 determines that the machining precision has not declined and ends the processing.

As described above, in the present embodiment, the receiving unit 411 of the length measurement control apparatus 400 receives the fitting information 241 that indicates the fitting state between the parts of the product that was assembled from the group of parts including members machined using the tool 140. The determination unit 412 of the length measurement control apparatus 400 determines whether to measure the length dimension of the tool 140 in order to correct the machining position, in accordance with a change in the length dimension of the tool 140, on the basis of whether the fitting state indicated in the fitting information 241 received by the receiving unit 411 is outside the threshold range.

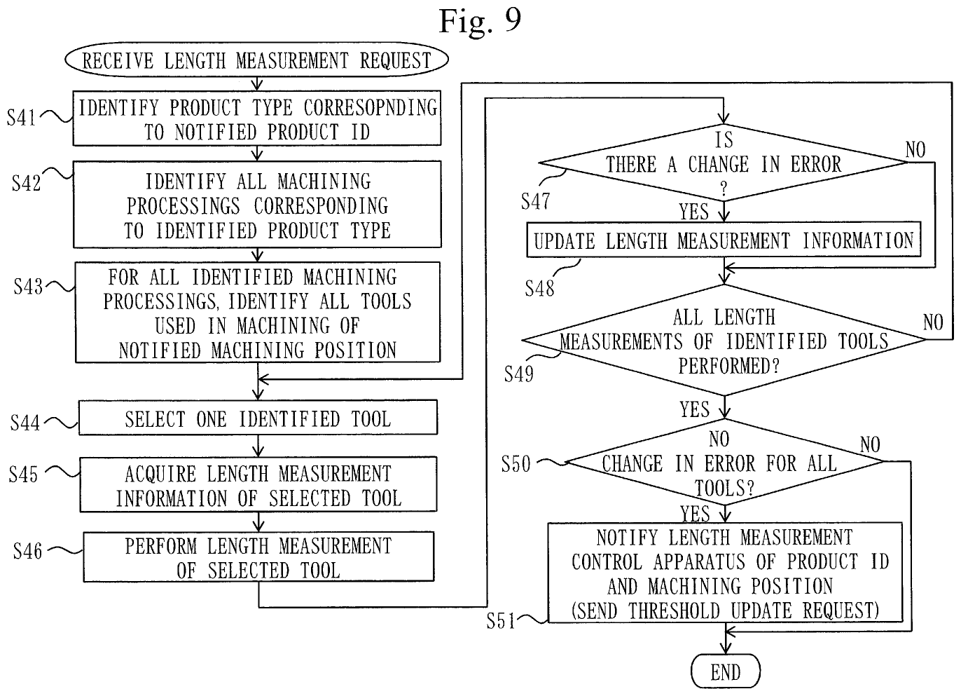

FIG. 9 illustrates a flow in which the length measurement program 122 is executed by the machining apparatus 100 that has received the length measurement request via the communication interface 112, and it is determined whether the threshold information 424 needs to be updated.

In step S41, the controller 110 identifies the product type on the basis of the product ID notified from the length measurement control apparatus 400. In step S42, the controller 110 identifies all of the machining processings corresponding to the product type. In step S43, the controller 110 identifies, in the identified machining processings, all of the tools 140 used in the machining of the machining position notified from the length measurement control apparatus 400. In step S44, the controller 110 selects one of the identified tools 140. In step S45, the controller 110 acquires the length measurement information 123 of the selected tool 140 from the memory 120. In step S46, the controller 110 uses the length measurement device 150 to perform a length measurement of the selected tool 140 and detects the dimensional error. In step S47, the controller 110 determines, on the basis of the length measurement information 123, whether there is a change in the dimensional error. When there is a change in the dimensional error, the controller 110 executes the processing of step S48. In step S48, the controller 110 updates the length measurement information 123. When there is no change in the dimensional error in step S47 or after the processing of step S48, the controller 110 executes the processing of step S49. In step S49, the controller 110 executes the processing of step S50 if the length measurement has been performed for all of the identified tools 140, and the controller 110 executes the processing of step S44 again if the length measurement has not been performed for all of the identified tools 140. In step S50, when there is a change in the dimensional error of even one of the identified tools 140, the controller 110 determines that the decline in machining precision was correctly detected and ends the processing. Meanwhile, when there are no changes in the dimensional errors of all of the identified tools 140, the controller 110 determines that the decline in machining precision was not correctly detected, that is, the controller 110 determines that the threshold information 424 needs to be updated, and executes the processing of step S51. In step S51, the controller 110 notifies the length measurement control apparatus 400 of the product ID and the machining position via the communication interface 112. As a result, a threshold update request is sent.

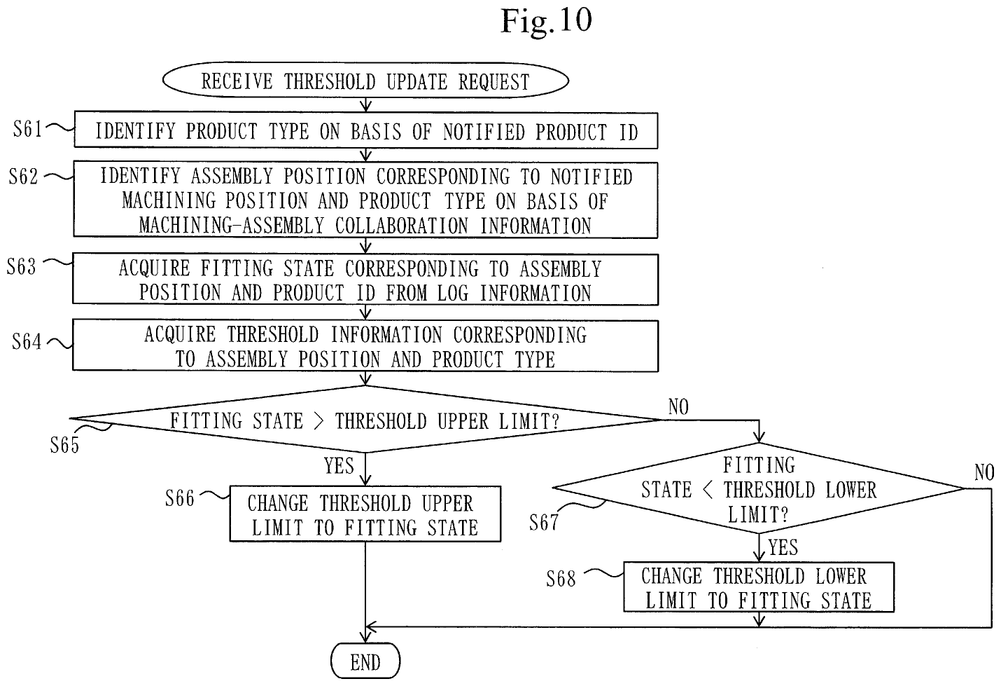

FIG. 10 illustrates a flow in which the threshold update program 422 is executed by the length measurement control apparatus 400 that received the threshold update request via the first communication interface 403, the threshold information 424 for detecting a decline in the machining precision is updated, and the threshold range is expanded.

In step S61, the determination unit 412 identifies the product type on the basis of the product ID notified from the machining apparatus 100. In step S62, the determination unit 412 identifies, on the basis of the machining-assembly collaboration information 425, the assembly position that corresponds to the product type and the machining position notified from the machining apparatus 100. In step S63, the determination unit 412 acquires, from the log information 426, the fitting state that corresponds to the assembly position and the product ID. In step S64, the determination unit 412 acquires the threshold information 424 that corresponds to the assembly position and the product type. In step S65, the determination unit 412 determines whether the fitting state is greater than an upper limit value of the threshold range of the threshold information 424. When the fitting state is greater than the upper limit value of the threshold range, the determination unit 412 executes the processing of step S66. In step S66, the determination unit 412 changes the upper limit value of the threshold range of the threshold information 424 to the fitting state. Meanwhile, when the fitting state is less than or equal to the upper limit value of the threshold range, the determination unit executes the processing of step S67. In step S67, the determination unit 412 determines whether the fitting state is less than a lower limit value of the threshold range of the threshold information 424. When the fitting state is less than the lower limit value of the threshold range, the determination unit 412 executes the processing of step S68. In step S68, the determination unit 412 changes the lower limit value of the threshold range of the threshold information 424 to the fitting state. Meanwhile, when the fitting state is greater than or equal to the lower limit value of the threshold range, the determination unit 412 ends the processing.

As described above, in the present embodiment, the length dimension of the tool 140 is measured depending on the determination results of the determination unit 412 of the length measurement control apparatus 400. When a different length measurement result, that differs from the length measurement result indicated in the length measurement information 123 stored in the memory 120, is obtained, the machining apparatus 100 updates the length measurement result, indicated in the length measurement information 123 stored in the memory 120, to the different length measurement results. Meanwhile, when a length measurement result, that is the same as the length measurement result indicated in the length measurement information 123 stored in the memory 120, is obtained, the machining apparatus 100 causes the length measurement control apparatus 400 to expand the threshold range.

When the machining apparatus 100 has used two or more tools 140 to machine a member included in the group of parts, the length dimensions of the two or more tools 140 are measured depending on the determination result of the determination unit 412 of the length measurement control apparatus 400. When a different length measurement result, that differs from the length measurement result indicated in the length measurement information 123 stored in the memory 120, is obtained for at least one tool 140 of the two or more tools 140, the machining apparatus 100 updates the length measurement result of the at least one tool 140 indicated in the length measurement information 123 stored in the memory 120 to the different length measurement result. Meanwhile, when length measurement results, that are the same as the length measurement results indicated in the length measurement information 123 stored in the memory 120, are obtained for all of the tools 140 of the two or more tools 140, the machining apparatus 100 causes the length measurement control apparatus 400 to expand the threshold range.

When expanding the threshold range, in cases in which the fitting state indicated in the fitting information 241 received by the receiving unit 411 is greater than the upper limit value of the threshold range, the length measurement control apparatus 400 updates the upper limit value of the threshold range to the same value as the fitting state indicated in the fitting information 241 received by the receiving unit 411.

When expanding the threshold range, in cases in which the fitting state indicated in the fitting information 241 received by the receiving unit 411 is less than the lower limit value of the threshold range, the length measurement control apparatus 400 updates the lower limit value of the threshold range to the same value as the fitting state indicated in the fitting information 241 received by the receiving unit 411.

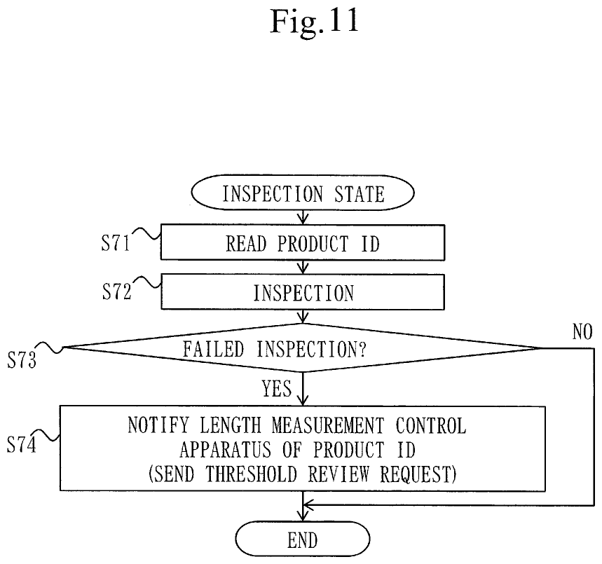

FIG. 11 illustrates a flow in which the inspection program 321 is executed by the inspection apparatus 300, products are inspected using the inspection mechanism 340, and only good products are shipped. In this flow, it is determined whether the threshold information 424 needs to be reviewed.

In step S71, the controller 310 uses the product ID reading device 330 to read the unique product ID associated with the product. In step S72, the controller 310 inspects the product using the inspection mechanism 340. In step S73, when the product has passed the inspection, the controller 310 determines that the product is a good product and ends the processing. Meanwhile, when the product fails the inspection, the controller 310 determines that the decline in machining precision was not correctly detected, that is, the controller 110 determines that the threshold information 424 needs to be reviewed, and executes the processing of step S74. In step S74, the controller 310 notifies the length measurement control apparatus 400 of the product ID via the communication interface 312. As a result, a threshold review request is sent.

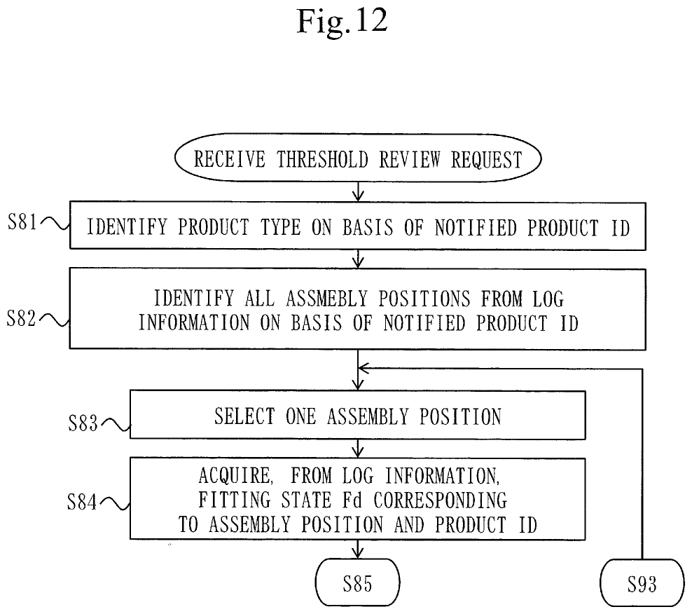

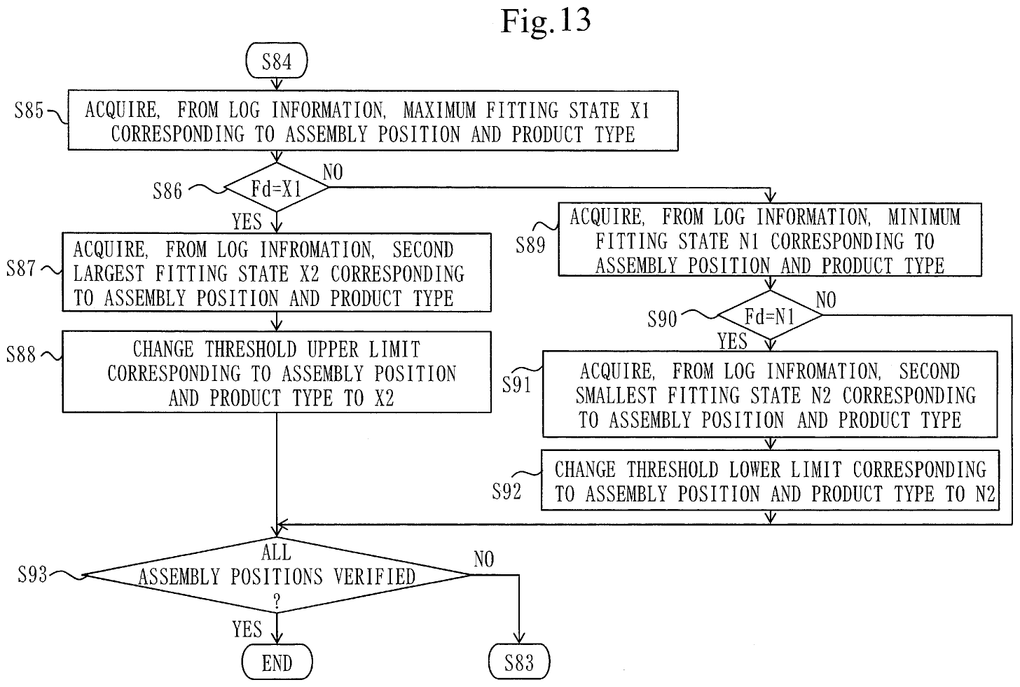

FIGS. 12 and 13 illustrates flows in which the threshold review program 423 is executed by the length measurement control apparatus 400 that received the threshold review request via the third communication interface 405, the threshold information 424 for detecting a decline in the machining precision is reviewed, and the threshold range is narrowed.

In step S81, the determination unit 412 identifies the product type on the basis of the product ID notified from the inspection apparatus 300. In step S82, the determination unit 412 identifies, on the basis of the log information 426, all of the assembly positions that correspond to the product ID. In step S83, the determination unit 412 selects one of the identified assembly positions. In step S84, the determination unit 412 acquires, from the log information 426, a fitting state Fd that corresponds to the assembly position and the product ID. In step S85, the determination unit 412 acquires, from the log information 426, a maximum fitting state X1 that corresponds to the assembly position and the product type. In step S86, the determination unit 412 determines whether the fitting state Fd and the maximum fitting state X1 match. When the fitting state Fd and the maximum fitting state X1 match, the determination unit 412 determines that the fitting state Fd is an outlier and that the threshold information 424 needs to be reviewed, and executes the processing of step S87. In step S87, the determination unit 412 acquires, from the log information 426, a second largest fitting state X2 that corresponds to the assembly position and the product ID. In step S88, the determination unit 412 changes the upper limit value of the threshold range of the threshold information 424 to the second largest fitting state X2. Meanwhile, when the fitting state Fd and the maximum fitting state X1 do not match, that is, when the fitting state Fd is not the maximum, the determination unit 412 executes the processing of step S89. In step S89, the determination unit 412 acquires, from the log information 426, a minimum fitting state N1 that corresponds to assembly position and the product type. In step S90, the determination unit 412 determines whether the fitting state Fd and the minimum fitting state N1 match. When the fitting state Fd and the minimum fitting state N1 match, the determination unit 412 determines that the fitting state Fd is an outlier and that the threshold information 424 needs to be reviewed, and executes the processing of step S91. In step S91, the determination unit 412 acquires, from the log information 426, a second smallest fitting state N2 that corresponds to the assembly position and the product ID. In step S92, the determination unit 412 changes the lower limit value of the threshold range of the threshold information 424 to the second smallest fitting state N2. Meanwhile, when the fitting state Fd and the minimum fitting state N1 do not match, that is, when the fitting state Fd is not the minimum, the determination unit 412 determines that the threshold information 424 does not need to be reviewed. In step S93, the determination unit 412 ends the processing if it has been verified, for all of the assembly positions, whether the threshold information 424 needs to be reviewed, and the determination unit 412 executes the processing of step S83 again if it has not been verified, for all of the assembly positions, whether the threshold information 424 needs to be reviewed.

As described above, in the present embodiment, the inspection apparatus 300 inspects whether the product satisfies a criteria. When the product does not satisfy the criteria, the inspection apparatus 300 causes the length measurement control apparatus 400 to narrow the threshold range.

In the present embodiment, the inspection apparatus 300 inspects whether two or more products satisfy the criteria. The inspection apparatus 300 notifies the length measurement control apparatus 400 of products, among the two or more products, that do not satisfy the criteria.

When narrowing the threshold range, in cases in which the fitting state, between the parts of a product notified from the inspection apparatus 300, indicated in the fitting information 241 received by the receiving unit 411 is greater than the fitting state between the parts of any of the other products indicated in the fitting information 241 received by the receiving unit 411, the length measurement control apparatus 400 updates the upper limit value of the threshold range to the same value as the next largest fitting state indicated in the fitting information 241 received by the receiving unit 411.

When narrowing the threshold range, in cases in which the fitting state, between the parts of a product notified from the inspection apparatus 300, indicated in the fitting information 241 received by the receiving unit 411 is less than the fitting state between the parts of any of the other products indicated in the fitting information 241 received by the receiving unit 411, the length measurement control apparatus 400 updates the lower limit value of the threshold range to the same value as the next smallest fitting state indicated in the fitting information 241 received by the receiving unit 411.

### Advantageous Effects of the Embodiment

As described above, with the present embodiment, the product is uniquely identified by reading the product ID, and the threshold information 424 for determining the precision of the tool 140 can be automatically updated. As such, it is possible to determine the length measurement timing at which decreases in workpiece machining efficiency can be minimized, regardless of the presence/absence of the experience of the worker and regardless of whether the production is variety and variable quantity production.

In the present embodiment, whether to measure the length dimension of the tool 140, that is, whether to perform a length measurement for correcting the machining position in accordance with a change in the length dimension of the tool 140 is determined by whether the fitting state between the parts in an assembled product is outside the threshold range. As such, it is possible to determine the length measurement timing at which decreases in machining precision and in machining efficiency can be suppressed, regardless of the presence/absence of the experience of the worker and regardless of whether the production is variety and variable quantity production.

In the present embodiment, precision decreases of the tool 140 of the machining apparatus 100 are determined at the time of assembly. That is, in the present embodiment, the length measurement is performed when a defect occurs in the assembly step. As such, declines in machining efficiency can be suppressed.

In the present embodiment, the threshold is automatically updated on the basis of the length measurement results and the inspection results. That is, in the present embodiment, when it is determined that correction is unnecessary at the time of length measurement, the criteria for defects are relaxed. As a result, machining efficiency can be improved while maintaining machining precision. Meanwhile, when the inspection is failed, the criteria for defects are made stricter. As a result, machining precision can be improved.

According to the present embodiment, an optimal length measurement timing of the tool 140 of the machining apparatus 100 can be determined using a threshold that is automatically updated. The optimal length measurement timing is a length measurement timing at which machining precision can be maintained while minimizing decreases in productivity.

According to the present embodiment, the optimal length measurement timing of the tool 140 of the machining apparatus 100 can be determined, even in the case of variety and variable quantity production, by reading the product ID and setting the threshold in accordance with the product type.

### OTHER CONFIGURATIONS

In the present embodiment, the length measurement device 150 is housed in the machining apparatus 100, thereby making it possible to automatically execute all operations from the detection of dimensional error to correction. However, the length measurement device 150 may exist outside the machining apparatus 100. In that case, the machining apparatus 100 that has received a length measurement instruction displays an alert on a display device that is connected to the machining apparatus 100, and a worker that sees this alert performs the length measurement of the tool 140 and inputs the length measurement information 123.

In the present embodiment, when reviewing the threshold information 424, it is determined whether the fitting state is an outlier by confirming whether the fitting state is the maximum or the minimum. However, this determination may be made by a common method in which standard deviation, normal distribution, or the like is used.

In the present embodiment, the inspection apparatus 300 automatically determines whether the product is good or poor, but a worker may perform this determination. In that case, the worker reads the product ID using the product ID reading device 130 such as a barcode reader, and inspects the product visually or by using equipment. Then, the worker inputs the inspection results into a terminal such as a personal computer, and notifies the length measurement control apparatus 400 of the product ID and the inspection results.

In the present embodiment, the functions of the “units” are realized by software, but a modification example is possible in which the functions of the “units” are realized by a combination of software and hardware. Specifically, a portion of the functions of the “units” may be realized by a dedicated electronic circuit, and the remaining functions may be realized by software.

Specifically, the dedicated electronic circuit is a single circuit, a composite circuit, a programmed processor, a parallel programmed processor, a logic IC, a GA, an FPGA, or an ASIC. “GA” is an abbreviation for “Gate Array.” “FPGA” is an abbreviation for “Field-Programmable Gate Array.” “ASIC” is an abbreviation for “Application Specific Integrated Circuit.”

The processor 401, the memory 402, and the dedicated electronic circuit are collectively referred to as “processing circuitry.” That is, regardless of whether the functions of the “units” are realized by software or by a combination of software and hardware, the functions of the “units” are realized by the processing circuitry.

The term “unit” may be interchanged with “procedure” or “processing.”

While an embodiment has been described, the embodiment may be partially implemented. Note that the present invention is not limited to the embodiment and various modifications can be made as necessary.

### REFERENCE SIGNS LIST

1: machining apparatus, 110: controller, 111: processor, 112: communication interface, 120: memory, 121: machining program. 122: length measurement program, 123: length measurement information, 130: product ID reading device, 140: tool, 150: length measurement apparatus, 200: assembly apparatus, 210: controller, 211: processor, 212: communication interface, 220: memory, 221: assembly program, 230: product ID reading device, 240: fitting state detection device, 241: fitting information, 250: assembly mechanism, 300: inspection apparatus, 310: controller, 311: processor, 312: communication interface, 320: memory, 321: inspection program, 330: product ID reading device, 340: inspection mechanism, 400: length measurement control apparatus, 401: processor, 402: memory, 403: first communication interface, 404: second communication interface, 405: third communication interface, 411: receiving unit, 412: determination unit, 420: auxiliary storage device, 421: fitting state determination program, 422: threshold update program, 423: threshold review program, 424: threshold information, 425: machining-assembly collaboration information, 426: log information, 500: manufacturing system, 510: network.

1-12. (canceled)

13. A length measurement control apparatus, comprising:
processing circuitry
to receive fitting information indicating a fitting state between parts of a product assembled from a group of parts including a member machined using a tool; and
to determine whether to measure a length dimension of the tool in order to correct a machining position in accordance with a change in the length dimension of the tool, on the basis of whether the fitting state indicated in the fitting information received is outside a threshold range.

14. A manufacturing system, comprising:
the length measurement control apparatus according to claim 13; and
a machining apparatus
to acquire, from a memory, length measurement information indicating a length measurement result that is a result of measuring the length dimension of the tool, to correct the machining position depending on the length measurement result indicated in the length measurement information acquired, and to machine the member using the tool by applying a machining position corrected; and
in case that the length dimension of the tool is measured depending on determination result determined, to update the length measurement result indicated in the length measurement information stored in the memory to a different length measurement result, when the different length measurement result, that differs from the length measurement result indicated in the length measurement information stored in the memory, is obtained, and to cause the length measurement control apparatus to expand the threshold range, when a length measurement result, that is the same as the length measurement result indicated in the length measurement information stored in the memory, is obtained.

15. The manufacturing system according to claim 14,
wherein in case that the machining apparatus uses, as the tool, two or more tools to machine the member included in the group of parts, and length dimensions of the two or more tools are measured depending on determination result determined, the machining apparatus updates the length measurement result of the at least one tool indicated in the length measurement information stored in the memory to the different length measurement result, when the different length measurement result, that differs from the length measurement result indicated in the length measurement information stored in the memory is obtained for at least one tool of the two or more tools, and the machining apparatus causes the length measurement control apparatus to expand the threshold range, when length measurement results, that is the same as the length measurement results indicated in the length measurement information stored in the memory, are obtained for all of the two or more tools.

16. The manufacturing system according to claim 14,
wherein when expanding the threshold range, in a case in which a fitting state indicated in fitting information received is greater than an upper limit value of the threshold range, the length measurement control apparatus updates the upper limit value of the threshold range to a value identical to the fitting state indicated in the fitting information received.

17. The manufacturing system according to claim 15,
wherein when expanding the threshold range, in a case in which a fitting state indicated in fitting information received is greater than an upper limit value of the threshold range, the length measurement control apparatus updates the upper limit value of the threshold range to a value identical to the fitting state indicated in the fitting information received.

18. The manufacturing system according to claim 14,
wherein when expanding the threshold range, in a case in which a fitting state indicated in fitting information received is less than a lower limit value of the threshold range, the length measurement control apparatus updates the lower limit value of the threshold range to a value identical to the fitting state indicated in the fitting information received.

19. The manufacturing system according to claim 15,
wherein when expanding the threshold range, in a case in which a fitting state indicated in fitting information received is less than a lower limit value of the threshold range, the length measurement control apparatus updates the lower limit value of the threshold range to a value identical to the fitting state indicated in the fitting information received.

20. The manufacturing system according to claim 16,
wherein when expanding the threshold range, in a case in which a fitting state indicated in fitting information received is less than a lower limit value of the threshold range, the length measurement control apparatus updates the lower limit value of the threshold range to a value identical to the fitting state indicated in the fitting information received.

21. The manufacturing system according to claim 17,
wherein when expanding the threshold range, in a case in which a fitting state indicated in fitting information received is less than a lower limit value of the threshold range, the length measurement control apparatus updates the lower limit value of the threshold range to a value identical to the fitting state indicated in the fitting information received.

22. A manufacturing system, comprising:
the length measurement control apparatus according to claim 13; and
an inspection apparatus to inspect whether or not the product satisfies a criteria and, when the product does not satisfy the criteria, to cause the length measurement control apparatus to narrow the threshold range.

23. The manufacturing system according to claim 22,
wherein the inspection apparatus inspects whether two or more products, as the product, satisfy the criteria, and notifies the length measurement control apparatus of a product among the two or more products that does not satisfy the criteria.

24. The manufacturing system according to claim 23,
wherein when narrowing the threshold range, in a case in which a fitting state, between parts of the product notified from the inspection apparatus, indicated in fitting information received is greater than a fitting state between parts of any other product indicated in the fitting information received, the length measurement control apparatus updates an upper limit value of the threshold range to a value identical to a next largest fitting state indicated in the fitting information received.

25. The manufacturing system according to claim 23,
wherein when narrowing the threshold range, in a case in which a fitting state, between parts of a product notified from the inspection apparatus, indicated in fitting information received is less than a fitting state between parts of any other product indicated in the fitting information received, the length measurement control apparatus updates a lower limit value of the threshold range to a value identical to a next smallest fitting state indicated in the fitting information received.

26. The manufacturing system according to claim 24,
wherein when narrowing the threshold range, in a case in which a fitting state, between parts of a product notified from the inspection apparatus, indicated in fitting information received is less than a fitting state between parts of any other product indicated in the fitting information received, the length measurement control apparatus updates a lower limit value of the threshold range to a value identical to a next smallest fitting state indicated in the fitting information received.

27. A manufacturing system, comprising:
the length measurement control apparatus according to claim 13; and
an assembly apparatus to assemble the product from the group of parts, detect a fitting state between the parts of the product, and send fitting information indicating the fitting state detected to the length measurement control apparatus.

28. A length measurement control method, comprising:
receiving fitting information indicating a fitting state between parts of a product assembled from a group of parts including a member machined using a tool; and
determining whether to measure a length dimension of the tool in order to correct a machining position in accordance with a change in the length dimension of the tool, on the basis of whether the fitting state indicated in the fitting information received is outside a threshold range.

29. A non-transitory computer readable medium storing a length measurement control program that causes a computer to execute:
processing to receive fitting information indicating a fitting state between parts of a product assembled from a group of parts including a member machined using a tool; and
processing to determine whether to measure a length dimension of the tool in order to correct a machining position in accordance with a change in the length dimension of the tool, on the basis of whether the fitting state indicated in the fitting information that is received is outside a threshold range.
